(19) United States
(12) Patent Application Publication
(10) Pub. No.: US 2022/0415527 A1
(43) Pub. Date: Dec. 29, 2022

(54) Combined power generation system and method of small fluoride-salt-cooled high-temperature reactor and solar tower

(71) Applicant: XI'AN JIAOTONG UNIVERSITY, XI'an (CN)

(72) Inventors: Dalin Zhang, XI'an (CN); Dianqiang Jiang, XI'an (CN); Xinyu Li, XI'an (CN); Xingguang Zhou, XI'an (CN); Chengiong Wang, XI'an (CN); Wenxi Tian, XI'an (CN); Suizheng Qiu, XI'an (CN); Guanghui Su, XI'an (CN)

(21) Appl. No.: 17/893,986

(22) Filed: Aug. 23, 2022

(30) Foreign Application Priority Data
Sep. 22, 2021 (CN) 202111105819.0

(51) Int. Cl. G21C 3/54; G21C 1/03; G21C 17/022; G21C 1/22; F24S 23/70; F24S 80/20

(52) U.S. Cl. CPC G21C 3/54; G21C 1/03; G21C 17/022; G21C 1/22; F24S 23/70; F24S 80/20

(57) ABSTRACT

A combined power generation system and method of a small fluoride-salt-cooled high-temperature reactor and solar tower is provided, which belongs to the field of new energy and renewable energy application and includes: a nuclear reactor power generation system, a solar tower power generation system and a heat compensation system. Both the nuclear reactor power generation system and the solar tower power generation system adopt supercritical carbon dioxide Brayton cycle system to generate electricity efficiently; molten salt pool in the nuclear reactor power generation system stores high-temperature heat from the modular reactor, and multi-stage temperature heat is utilized for generating power and compensating heat required by the solar tower power generation system.

### CROSS REFERENCE OF RELATED APPLICATION

The present application claims priority under 35 U.S.C. 119(a-d) to CN 202111105819.0, filed Sep. 22, 2021.

### BACKGROUND OF THE PRESENT INVENTION

### Field of Invention

The invention relates to the field of new energy and renewable energy application, and more particularly to a combined power generation system and method of a small fluoride-salt-cooled high-temperature reactor and solar tower.

### Description of Related Arts

In order to promote the green and low-carbon transformation of the energy system and increase the utilization ratio of renewable energy, it is necessary to develop hydropower, geothermal energy, wind energy and solar energy according to local conditions. Among them, solar thermal power generation has become an important direction of renewable energy utilization. The biggest advantage of solar thermal power generation is that the power output is relatively stable. Because of its reliable energy storage configuration, it can continue to generate electricity at night. Its main forms include trough type, tower and dish systems. The molten salt working fluid temperature of the solar tower power generation system is generally higher than 500° C., which can match the water vapor Rankine cycle system. In addition, when encountering a long cloudy day, the solar tower power generation system cannot run smoothly, so it is necessary to further improve the stability and reliability of the power supply of the system.

At the beginning of the 21st century, Oak Ridge National Laboratory proposed a molten-salt-cooled solid fuel reactor, namely fluoride-salt-cooled high-temperature reactor (FHR). Fluoride salt only serves as a coolant, not as a fission fuel. FHR combines the high-temperature and high-burnup fuel technology of high-temperature gas-cooled reactor, the high-temperature and low-pressure molten-salt-cooled technology of the molten salt reactor and the passive safety technology of liquid metal cooled fast reactor, which further improves the safety and low cost of reactor operation. The advantages of the FHR are prominent in various types of reactors. Among them, the application of small FHR is more flexible, and its core outlet temperature is close to 700° C., which can match the supercritical carbon dioxide Brayton cycle system and improve the power generation efficiency of the system. However, the high-temperature heat of FHR should have other multi-stage utilizations while improving the power generation efficiency of the system, thereby improving the economic efficiency of small FHRs. Therefore, it is necessary to design a multistage and multipurpose application method for the small FHRs.

### SUMMARY OF THE PRESENT INVENTION

In order to overcome the problems existed in the above-mentioned conventional arts, an object of the present invention is to provide a combined power generation system and method of a small fluoride-salt-cooled high-temperature reactor and solar tower, which utilizes the multi-stage high-temperature heat of the molten salt pool, and the small fluorid-salt-cooled high-temperature reactor combines solar tower power generation can not only achieve high efficient utilization of energy, but also further improve the stability and reliability of solar tower power generation.

In order to achieve the above object, the present invention adopts the following technical solutions.

A combined power generation system of a small fluoride-salt-cooled high-temperature reactor and solar tower, comprises: a nuclear reactor power generation system, a solar tower power generation system and a heat compensation system; wherein:

the nuclear reactor power generation system includes a modular reactor 1, a secondary-circuit molten salt pump 2, a molten salt pool 3, a molten salt pool temperature monitoring system 4, a molten salt pool temperature measurement system 5, a FLiNaK—CO₂ heat exchanger 6 and a nuclear reactor-supercritical carbon dioxide Brayton cycle system 7; an outlet of the modular reactor 1 is connected to an inlet of the molten salt pool 3, and an outlet of the molten salt pool 3 is connected to an inlet of the secondary circuit molten salt pump 2, an outlet of the secondary circuit molten salt pump 2 is connected to an inlet of the modular reactor 1; the molten salt pool temperature measurement system 5 and the FLiNaK—CO₂ heat exchanger 6 are located in the molten salt pool 3, the molten salt pool temperature monitoring system 4 is located outside the molten salt pool 3 and is connected to the molten salt pool temperature measurement system 5, a cold side of the FLiNaK—CO₂ heat exchanger 6 is connected to the nuclear reactor-supercritical carbon dioxide Brayton cycle system 7, and a power generation device in the nuclear reactor-supercritical carbon dioxide Brayton cycle system 7 is connected to the power grid 9;

the solar tower power generation system comprises: a heliostat field 10, a receiving tower 11, a receiver 12, a diverter valve 13, a confluence valve 14, a KNO₃/NaNO₃—CO₂ heat exchanger 15, a low temperature heat storage tank 16, a solar system molten salt pump 17 and a solar-supercritical carbon dioxide Brayton cycle system 18; wherein the heliostat field 10 is located below the receiving tower 11, the receiver 12 is provided at the top of the receiving tower 11, the molten salt flow pipe is provided in the receiver 12, an outlet of the molten salt flow pipe is connected to the inlet of the diverter valve 13.1, and a first outlet of the diverter valve 13.2 is connected to a first inlet of the confluence valve 14.1, an outlet of the confluence valve 14.2 is connected to an inlet o a hot side of the KNO₃/NaNO₃—CO₂ heat exchanger 15, and an outlet on a hot side of the KNO₃/NaNO₃—CO₂ heat exchanger 15 is connected to an inlet of the low temperature heat storage tank 16, an outlet of the low temperature heat storage tank 16 is connected to an inlet of the molten salt pump 17 of the solar energy system, and an outlet of the molten salt pump 17 of the solar energy system is connected to an inlet of the molten salt flow pipeline in the receiver 12, a cold side of the KNO₃/NaNO₃—CO₂ heat exchanger 15 is connected to the solar-supercritical carbon dioxide Brayton cycle system 18, and a power generation device in the solar-supercritical carbon dioxide Brayton cycle system 18 is connected to the power grid 9;

the heat compensation system shares the diverter valve 13 and the confluence valve 14 with the solar tower power generation system, and further comprises a FLiNaK—KNO₃/NaNO₃ heat exchanger 8 and a flow control system 19, wherein pipelines between the diverter valve 13 and the confluence valve 14 in the heat compensation system and the solar tower power generation system are connected in parallel; a second outlet 13.3 of the diverter valve is connected to an inlet on a cold side of the flow control system 19, and an outlet of the flow control system 19 is connected to an inlet on a cold side of the FLiNaK—KNO₃/NaNO₃ heat exchanger 8, an outlet on a cold side of the FLiNaK—KNO₃/NaNO₃ heat exchanger 8 is connected to a second inlet of the confluence valve 14.3, and the FLiNaK—KNO₃/NaNO₃ heat exchanger 8 is provided in the molten salt pool 3.

Preferably, the FLiNaK—CO₂ heat exchanger 6 is provided above the FLiNaK—KNO₃/NaNO₃ heat exchanger 8.

Preferably, an outlet temperature of the modular reactor 1 in the nuclear reactor power generation system is 690-700° C., the modular reactor 1 adopts FLiBe salt as a main coolant of the modular reactor 1, and moles of LiF and BeF₂ are respectively 67% and 33%; FLiNaK salt is adopted as a cooling medium in the secondary circuit where the secondary circuit molten salt pump 2 is located, and mole fractions of LiF, NaF and KF are 46.5%, 11.5% and 42% respectively; the solar tower power generation system adopts a mixed salt of KNO₃ and NaNO₃ as circulating working fluid, wherein a mass fractions of KNO₃ and NaNO₃ are 40% and 60% respectively.

Preferably, when solar energy is sufficient, the molten salt flows out through the first outlet 13.2 of the diverter valve, the second outlet 13.3 of the diverter valve is closed, molten salt flows into the first inlet of the confluence valve 14.1, and the second inlet of the confluence valve 14.3 is closed; when the solar energy insufficient, the molten salt flows out through the second outlet of the diverter valve 13.3, the first outlet of the diverter valve 13.3 is closed, the molten salt flows into the second inlet of the confluence valve 14.3, and the first inlet of the confluence valve 14.1 is closed.

Preferably, the molten salt pool temperature measurement system 5 measures the temperature at different depths in the molten salt pool 3, the molten salt pool temperature monitoring system 4 monitors the temperature measured from the molten salt pool temperature measurement system 5, the molten salt pool temperature monitoring system 4 feedback the temperature result to the flow control system 19, and the flow control system 19 automatically controls the flow according to the temperature result, thereby ensuring the stable power generation of the solar tower power generation system.

Preferably, both the nuclear reactor-supercritical carbon dioxide Brayton cycle system 7 in the nuclear reactor power generation system and the solar-supercritical carbon dioxide Brayton cycle system 18 in the solar tower power generation system use CO₂ as a circulating working medium, and the cooling medium at the cold end is air.

Preferably, a working process of the nuclear reactor power generation system is as follows: the modular reactor 1 serves as a heat source of the nuclear reactor power generation system, and the low-temperature molten salt in the molten salt pool 3 is pressurized by the secondary circuit molten salt pump 2, enters the modular reactor 1 to perform heating, and then flows into the molten salt pool for heat storage, and heat CO₂ in a clod side of the FLiNaK—CO₂ heat exchanger 6 and KNO₃/NaNO₃ salt on a cold side of the FLiNaK—KNO₃/NaNO₃ heat exchanger 8; the cold side of the FLiNaK—CO₂ heat exchanger 6 completes the cycle in the nuclear reactor-supercritical carbon dioxide Brayton cycle system 7 by the CO₂ heated thereon, and transmits electrical energy to an external power grid 9;

wherein a working process of the solar tower power generation system is as follows: adopting a heliostat field 10 that automatically tracks solar radiation, the solar energy irradiated on the heliostat field 10 is reflected and concentrated on a receiver 12 above the receiving tower 11; the molten salt in the molten salt flow pipeline is heated, and heated molten salt flows through the diverter valve 13 and the confluence valve 14 and then enters a hot side of the KNO₃/NaNO₃—CO₂ heat exchanger 15 to heat CO₂ in the solar energy supercritical carbon dioxide Brayton cycle system 18 to completes the cycle in the solar-supercritical carbon dioxide Brayton cycle system 18, and electric energy is transmitted to the external power grid 9, and the molten salt after heat release is pressurized by the molten salt pump 17 of the solar energy system and then enters the molten salt flow pipeline in the receiver 12 to be heated by the solar energy again;

wherein a working process of the heat compensation system is as follows: when the receiver 12 no longer receives heat from the solar energy, the diverter valve 13 switches the outlet, the confluence valve 14 switches the inlet, and the molten salt flows out of the diverter valve 13, and passes through the diverter valve 13, wherein the flow control system 19 controls capacity of the flow, and the flow enters the solar tower power generation system through the confluence valve 14 after the cold side of the FLiNaK—KNO₃/NaNO₃ heat exchanger 8 is heated.

Compared with the conventional arts, the present invention has the following beneficial effects.

1. Both the small fluoride-salt-cooled high-temperature reactor and the solar tower power generation system of the present invention adopt supercritical carbon dioxide Brayton cycle system, and the system has high power generation efficiency and less water demand, and can generate power in water-deficient areas.

2. The small fluoride-salt-cooled high-temperature reactor of the present invention utilizes the molten salt pool for energy storage, and provides multi-level temperature heat to the outside by monitoring the temperature levels of different depths of the molten salt pool, which has more economic efficiency.

3. The present invention utilizes high-temperature heat output by small fluoride-salt-cooled high-temperature reactor, a first part of which is used for high-efficiency power generation, and a second part is used to deliver high-temperature heat to the solar tower power generation system at night and on cloudy days, in such a manner that the solar power generation system saves the need for high-temperature thermal storage tank, and the stability and reliability of solar tower power generation is further improved.

### BRIEF DESCRIPTION OF THE DRAWINGS

FIG. 1 is a schematic structural diagram of the present invention, comprising a schematic diagram of the inlet and outlet of the diverter valve and the confluence valve;

In the Figure: 1-modular reactor; 2-secondary circuit molten salt pump; 3-molten salt pool; 4-molten salt pool temperature monitoring system; 5-molten salt pool temperature measurement system; 6-FLiNaK—CO₂ heat exchanger; 7-nuclear reactor-supercritical carbon dioxide Brayton cycle system; 8-FLiNaK—KNO₃/NaNO₃ heat exchanger; 9-power grid; 10-heliostat field; 11-receiving tower; 12-receiver; 13-valve inlet, 13.2-first outlet of the diverter valve, 13.3-second outlet of the diverter valve; 14-confluence valve; 14.1-first inlet of the confluence valve, 14.2-outlet of the confluence valve, 14.3-second inlet of the confluence valve; 15-KNO₃/NaNO₃—CO₂ heat exchanger; 16-low temperature heat storage tank; 17-solar system molten salt pump; 18-solar energy-supercritical carbon dioxide Brayton cycle system; 19-flow control system.

### DETAILED DESCRIPTION OF THE PREFERRED EMBODIMENT

The present invention provides a combined power generation system of a small fluoride-salt-cooled high-temperature reactor and solar tower, which is illustrated in detail with the accompanying drawing.

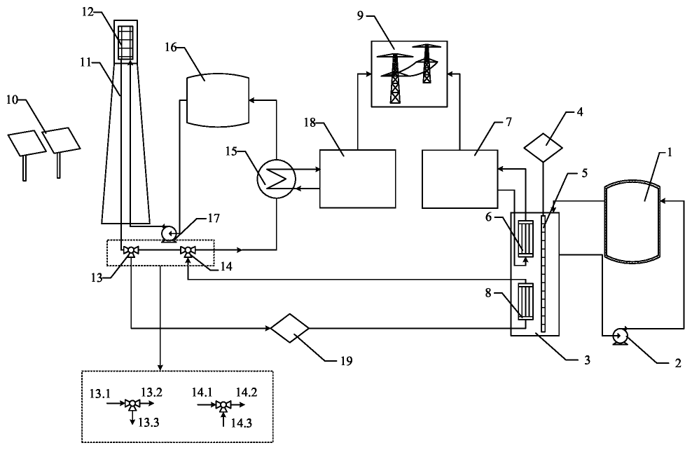

As shown in FIG. 1, according to a preferred embodiment of the present invention is provides, a combined power generation system of a small fluoride-salt-cooled high-temperature reactor and solar tower, comprises: a nuclear reactor power generation system, a solar tower power generation system and a heat compensation system; wherein:

the nuclear reactor power generation system includes a modular reactor 1, a secondary-circuit molten salt pump 2, a molten salt pool 3, a molten salt pool temperature monitoring system 4, a molten salt pool temperature measurement system 5, a FLiNaK—CO₂ heat exchanger 6 and a nuclear reactor-supercritical carbon dioxide Brayton cycle system 7; an outlet of the modular reactor 1 is connected to an inlet of the molten salt pool 3, and an outlet of the molten salt pool 3 is connected to an inlet of the secondary circuit molten salt pump 2, an outlet of the secondary circuit molten salt pump 2 is connected to an inlet of the modular reactor 1; the molten salt pool temperature measurement system 5 and the FLiNaK—CO₂ heat exchanger 6 are located in the molten salt pool 3, the molten salt pool temperature monitoring system 4 is located outside the molten salt pool 3 and is connected to the molten salt pool temperature measurement system 5, a cold side of the FLiNaK—CO₂ heat exchanger 6 is connected to the nuclear reactor-supercritical carbon dioxide Brayton cycle system 7, and a power generation device in the nuclear reactor-supercritical carbon dioxide Brayton cycle system 7 is connected to the power grid 9;

the solar tower power generation system comprises: a heliostat field 10, a receiving tower 11, a receiver 12, a diverter valve 13, a confluence valve 14, a KNO₃/NaNO₃—CO₂ heat exchanger 15, a low temperature heat storage tank 16, a solar system molten salt pump 17 and a solar-supercritical carbon dioxide Brayton cycle system 18; wherein the heliostat field 10 is located below the receiving tower 11, the receiver 12 is provided at the top of the receiving tower 11, the molten salt flow pipe is provided in the receiver 12, an outlet of the molten salt flow pipe is connected to the inlet of the diverter valve 13.1, and a first outlet of the diverter valve 13.2 is connected to a first inlet of the confluence valve 14.1, an outlet of the confluence valve 14.2 is connected to an inlet o a hot side of the KNO₃/NaNO3—CO₂ heat exchanger 15, and an outlet on a hot side of the KNO₃/NaNO₃—CO₂ heat exchanger 15 is connected to an inlet of the low temperature heat storage tank 16, an outlet of the low temperature heat storage tank 16 is connected to an inlet of the molten salt pump 17 of the solar energy system, and an outlet of the molten salt pump 17 of the solar energy system is connected to an inlet of the molten salt flow pipeline in the receiver 12, a cold side of the KNO₃/NaNO₃—CO₂ heat exchanger 15 is connected to the solar-supercritical carbon dioxide Brayton cycle system 18, and a power generation device in the solar-supercritical carbon dioxide Brayton cycle system 18 is connected to the power grid 9;

the heat compensation system shares the diverter valve 13 and the confluence valve 14 with the solar tower power generation system, and further comprises a FLiNaK—KNO₃/NaNO₃ heat exchanger 8 and a flow control system 19, wherein pipelines between the diverter valve 13 and the confluence valve 14 in the heat compensation system and the solar tower power generation system are connected in parallel; a second outlet of the diverter valve 13.3 is connected to an inlet on a cold side of the flow control system 19, and an outlet of the flow control system 19 is connected to an inlet on a cold side of the FLiNaK—KNO₃/NaNO₃ heat exchanger 8, an outlet on a cold side of the FLiNaK—KNO₃/NaNO₃ heat exchanger 8 is connected to a second inlet of the confluence valve 14.3, and the FLiNaK—KNO₃/NaNO₃ heat exchanger 8 is provided in the molten salt pool 3.

According to the preferred embodiment of the present invention, the FLiNaK—CO₂ heat exchanger 6 is provided above the FLiNaK—KNO₃/NaNO₃ heat exchanger 8.

According to the preferred embodiment of the present invention, the FLiNaK—CO₂ heat exchanger 6 is a printed circuit board heat exchanger, and the FLiNaK—KNO₃/NaNO₃ heat exchanger 8 is a shell and tube heat exchanger;

According to the preferred embodiment of the present invention, an outlet temperature of the modular reactor 1 in the nuclear reactor power generation system is 690-700° C., the modular reactor 1 adopts FLiBe salt as a main coolant of the modular reactor 1, and moles of LiF and BeF₂ are respectively 67% and 33%; FLiNaK salt is adopted as a cooling medium in the secondary circuit where the secondary circuit molten salt pump 2 is located, and mole fractions of LiF, NaF and KF are 46.5%, 11.5% and 42% respectively; the solar tower power generation system adopts a mixed salt of KNO₃ and NaNO₃ as circulating working fluid, wherein a mass fractions of KNO₃ and NaNO₃ are 40% and 60% respectively.

According to the preferred embodiment of the present invention, the modular reactor 1 adopts a modular design, and a thermal power is 125 MW; when the electric energy demand exceeds the power generation of a single modular reactor 1, the configuration quantity of the modular reactor 1 can be increased.

According to the preferred embodiment of the present invention, when solar energy is sufficient, the molten salt flows out through the first outlet 13.2 of the diverter valve, the second outlet of the diverter valve 13.3 is closed, molten salt flows into the first inlet 14.1 of the confluence valve, and the second inlet of the confluence 14.3 valve is closed; when the solar energy insufficient, the molten salt flows out through the second outlet of the diverter valve 13.3, the first outlet of the diverter valve 13.3 is closed, the molten salt flows into the second inlet of the confluence valve 14.3, and the first inlet of the confluence valve 14.1 is closed.

According to the preferred embodiment of the present invention, the molten salt pool temperature measurement system 5 measures the temperature at different depths in the molten salt pool 3, the molten salt pool temperature monitoring system 4 monitors the temperature measured from the molten salt pool temperature measurement system 5, the molten salt pool temperature monitoring system 4 feedback the temperature result to the flow control system 19, and the flow control system 19 automatically controls the flow according to the temperature result, thereby ensuring the stable power generation of the solar tower power generation system.

According to the preferred embodiment of the present invention, the solar power generation system of the present invention is not provided with a high temperature heat storage tank, but only a low temperature heat storage tank 16 is provided, thereby reducing the construction cost of the solar tower power generation system; the low temperature heat storage tank 16 is a storage device for low temperature molten salt, which can ensure the main circuit of the solar tower power generation system has enough molten salt to participate in the circulation.

According to the preferred embodiment of the present invention, both the nuclear reactor-supercritical carbon dioxide Brayton cycle system 7 in the nuclear reactor power generation system and the solar-supercritical carbon dioxide Brayton cycle system 18 in the solar tower power generation system use CO₂ as a circulating working medium, and the cooling medium at the cold end is air.

According to the preferred embodiment of the present invention, the thermal efficiency of the nuclear reactor-supercritical carbon dioxide Brayton cycle system 7 in the nuclear reactor power generation system and the solar-supercritical carbon dioxide Brayton cycle system 18 in the solar tower power generation system is greater than 45%.

According to the preferred embodiment of the present invention, a working process of the nuclear reactor power generation system is as follows: the modular reactor 1 serves as a heat source of the nuclear reactor power generation system, and the low-temperature molten salt in the molten salt pool 3 is pressurized by the secondary circuit molten salt pump 2, enters the modular reactor 1 to perform heating, and then flows into the molten salt pool for heat storage, and heat CO₂ in a clod side of the FLiNaK—CO₂ heat exchanger 6 and KNO₃/NaNO₃ salt on a cold side of the FLiNaK—KNO₃/NaNO₃ heat exchanger 8; the cold side of the FLiNaK—CO₂ heat exchanger 6 completes the cycle in the nuclear reactor-supercritical carbon dioxide Brayton cycle system 7 by the CO₂ heated thereon, and transmits electrical energy to an external power grid 9;

wherein a working process of the solar tower power generation system is as follows: adopting a heliostat field 10 that automatically tracks solar radiation, the solar energy irradiated on the heliostat field 10 is reflected and concentrated on a receiver 12 above the receiving tower 11; the molten salt in the molten salt flow pipeline is heated, and heated molten salt flows through the diverter valve 13 and the confluence valve 14 and then enters a hot side of the KNO₃/NaNO₃—CO₂ heat exchanger 15 to heat CO₂ in the solar energy supercritical carbon dioxide Brayton cycle system 18 to completes the cycle in the solar-supercritical carbon dioxide Brayton cycle system 18, and electric energy is transmitted to the external power grid 9, and the molten salt after heat release is pressurized by the molten salt pump 17 of the solar energy system and then enters the molten salt flow pipeline in the receiver 12 to be heated by the solar energy again;

wherein a working process of the heat compensation system is as follows: when the receiver 12 no longer receives heat from the solar energy, the diverter valve 13 switches the outlet, the confluence valve 14 switches the inlet, and the molten salt flows out of the diverter valve 13, and passes through the diverter valve 13, wherein the flow control system 19 controls capacity of the flow, and the flow enters the solar tower power generation system through the confluence valve 14 after the cold side of the FLiNaK—KNO₃/NaNO₃ heat exchanger 8 is heated.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A combined power generation system of a small fluoride-salt-cooled high-temperature reactor and solar tower, comprising: a nuclear reactor power generation system, a solar tower power generation system and a heat compensation system; wherein:
the nuclear reactor power generation system includes a modular reactor (1), a secondary-circuit molten salt pump (2), a molten salt pool (3), a molten salt pool temperature monitoring system (4), a molten salt pool temperature measurement system (5), a FLiNaK—CO₂ heat exchanger (6) and a nuclear reactor-supercritical carbon dioxide Brayton cycle system (7); an outlet of the modular reactor (1) is connected to an inlet of the molten salt pool (3), and an outlet of the molten salt pool (3) is connected to an inlet of the secondary circuit molten salt pump (2), an outlet of the secondary circuit molten salt pump (2) is connected to an inlet of the modular reactor (1); the molten salt pool temperature measurement system (5) and the FLiNaK—CO₂ heat exchanger (6) are located in the molten salt pool (3), the molten salt pool temperature monitoring system (4) is located outside the molten salt pool (3) and is connected to the molten salt pool temperature measurement system (5), a cold side of the FLiNaK—CO₂ heat exchanger (6) is connected to the nuclear reactor-supercritical carbon dioxide Brayton cycle system (7), and a power generation device in the nuclear reactor-supercritical carbon dioxide Brayton cycle system (7) is connected to the power grid (9);
the solar tower power generation system comprises: a heliostat field (10), a receiving tower (11), a receiver (12), a diverter valve (13), a confluence valve (14), a KNO₃/NaNO₃—CO₂ heat exchanger (15), a low temperature heat storage tank (16), a solar system molten salt pump (17) and a solar-supercritical carbon dioxide Brayton cycle system (18); wherein the heliostat field (10) is located below the receiving tower (11), the receiver (12) is provided at the top of the receiving tower (11), the molten salt flow pipe is provided in the receiver (12), an outlet of the molten salt flow pipe is connected to the inlet of the diverter valve (13.1), and a first outlet of the diverter valve (13.2) is connected to a first inlet of the confluence valve (14.1), an outlet of the confluence valve (14.2) is connected to an inlet o a hot side of the KNO₃/NaNO3—CO₂ heat exchanger (15), and an outlet on a hot side of the KNO₃/NaNO₃—CO₂ heat exchanger (15) is connected to an inlet of the low temperature heat storage tank (16), an outlet of the low temperature heat storage tank (16) is connected to an inlet of the molten salt pump (17) of the solar energy system, and an outlet of the molten salt pump (17) of the solar energy system is connected to an inlet of the molten salt flow pipeline in the receiver (12), a cold side of the KNO₃/NaNO₃—CO₂ heat exchanger (15) is connected to the solar-supercritical carbon dioxide Brayton cycle system (18), and a power generation device in the solar-supercritical carbon dioxide Brayton cycle system (18) is connected to the power grid (9);
the heat compensation system shares the diverter valve (13) and the confluence valve (14) with the solar tower power generation system, and further comprises a FLiNaK—KNO₃/NaNO₃ heat exchanger (8) and a flow control system (19), wherein pipelines between the diverter valve (13) and the confluence valve (14) in the heat compensation system and the solar tower power generation system are connected in parallel; a second outlet of the diverter valve (13.3) is connected to an inlet on a cold side of the flow control system (19), and an outlet of the flow control system (19) is connected to an inlet on a cold side of the FLiNaK—KNO₃/NaNO₃ heat exchanger (8), an outlet on a cold side of the FLiNaK—KNO₃/NaNO₃ heat exchanger (8) is connected to a second inlet of the confluence valve (14.3), and the FLiNaK—KNO₃/NaNO₃ heat exchanger (8) is provided in the molten salt pool (3).

2. The combined power generation system of the small fluoride-salt-cooled high-temperature reactor and the solar tower, as recited in claim 1, wherein the FLiNaK—CO₂ heat exchanger (6) is provided above the FLiNaK—KNO₃/NaNO₃ heat exchanger (8).

3. The combined power generation system of the small fluoride-salt-cooled high-temperature reactor and the solar tower, as recited in claim 1, wherein an outlet temperature of the modular reactor (1) in the nuclear reactor power generation system is 690-700° C., the modular reactor (1) adopts FLiBe salt as a main coolant of the modular reactor (1), and moles of LiF and BeF₂ are respectively 67% and 33%; FLiNaK salt is adopted as a cooling medium in the secondary circuit where the secondary circuit molten salt pump (2) is located, and mole fractions of LiF, NaF and KF are 46.5%, 11.5% and 42% respectively; the solar tower power generation system adopts a mixed salt of KNO₃ and NaNO₃ as circulating working fluid, wherein a mass fractions of KNO₃ and NaNO₃ are 40% and 60% respectively.

4. The combined power generation system of the small fluoride-salt-cooled high-temperature reactor and the solar tower, as recited in claim 1, wherein when solar energy is sufficient, the molten salt flows out through the first outlet of the diverter valve (13.2), the second outlet of the diverter valve (13.3) is closed, molten salt flows into the first inlet of the confluence valve (14.1), and the second inlet of the confluence valve (14.3)is closed; when the solar energy insufficient, the molten salt flows out through the second outlet of the diverter valve (13.3), the first outlet of the diverter valve (13.3) is closed, the molten salt flows into the second inlet of the confluence valve (14.3), and the first inlet of the confluence valve (14.1) is closed.

5. The combined power generation system of the small fluoride-salt-cooled high-temperature reactor and the solar tower, as recited in claim 1, wherein the molten salt pool temperature measurement system (5) measures the temperature at different depths in the molten salt pool (3), the molten salt pool temperature monitoring system (4) monitors the temperature measured from the molten salt pool temperature measurement system (5), the molten salt pool temperature monitoring system (4)) feedback the temperature result to the flow control system (19), and the flow control system (19) automatically controls the flow according to the temperature result, thereby ensuring the stable power generation of the solar tower power generation system.

6. The combined power generation system of the small fluoride-salt-cooled high-temperature reactor and the solar tower, as recited in claim 1, wherein both the nuclear reactor-supercritical carbon dioxide Brayton cycle system (7) in the nuclear reactor power generation system and the solar-supercritical carbon dioxide Brayton cycle system (18) in the solar tower power generation system use CO₂ as a circulating working medium, and the cooling medium at the cold end is air.

7. The combined power generation system of the small fluoride-salt-cooled high-temperature reactor and the solar tower, as recited in claim 1, wherein a working process of the nuclear reactor power generation system is as follows: the modular reactor (1) serves as a heat source of the nuclear reactor power generation system, and the low-temperature molten salt in the molten salt pool (3) is pressurized by the secondary circuit molten salt pump (2), enters the modular reactor (1) to perform heating, and then flows into the molten salt pool for heat storage, and heat CO₂ in a clod side of the FLiNaK—CO₂ heat exchanger (6) and KNO₃/NaNO₃ salt on a cold side of the FLiNaK—KNO₃/NaNO₃ heat exchanger (8); the cold side of the FLiNaK—CO₂ heat exchanger (6) completes the cycle in the nuclear reactor-supercritical carbon dioxide Brayton cycle system (7) by the CO₂ heated thereon, and transmits electrical energy to an external power grid (9);
wherein a working process of the solar tower power generation system is as follows: adopting a heliostat field (10) that automatically tracks solar radiation, the solar energy irradiated on the heliostat field (10) is reflected and concentrated on a receiver (12) above the receiving tower (11); the molten salt in the molten salt flow pipeline is heated, and heated molten salt flows through the diverter valve (13) and the confluence valve (14) and then enters a hot side of the KNO₃/NaNO₃—CO₂ heat exchanger (15) to heat CO₂ in the solar energy supercritical carbon dioxide Brayton cycle system (18) to completes the cycle in the solar-supercritical carbon dioxide Brayton cycle system (18), and electric energy is transmitted to the external power grid (9), and the molten salt after heat release is pressurized by the molten salt pump (17) of the solar energy system and then enters the molten salt flow pipeline in the receiver (12) to be heated by the solar energy again;
wherein a working process of the heat compensation system is as follows: when the receiver (12) no longer receives heat from the solar energy, the diverter valve (13) switches the outlet, the confluence valve (14) switches the inlet, and the molten salt flows out of the diverter valve (13), and passes through the diverter valve (13), wherein the flow control system (19) controls capacity of the flow, and the flow enters the solar tower power generation system through the confluence valve (14) after the cold side of the FLiNaK—KNO₃/NaNO₃ heat exchanger (8) is heated.
